(19) United States
(12) Patent Application Publication
(10) Pub. No.: US 2026/0284697 A1
(43) Pub. Date: Sep. 24, 2026

(54) APPARATUS AND METHOD FOR COATING A COMPONENT, IN PARTICULAR A FLOOR ELEMENT, AND APPARATUS FOR PRODUCING A COMPONENT, IN PARTICULAR A FLOOR ELEMENT

(71) Applicant: JOSEF SCHIELE, Niederzissen (DE)

(72) Inventors: Stefan Schiele, Niederzissen (DE); Matthias Gros, Niederzissen (DE)

(21) Appl. No.: 19/475,624

(22) PCT Filed: Apr. 19, 2024
(86) PCT No.: PCT/EP2024/060737

§ 371 Date: Oct. 15, 2025

(30) Foreign Application Priority Data
Apr. 20, 2023 (DE) 10 2023 110 073.4

(51) Int. Cl. B05C 11/10; B05B 12/12

(52) U.S. Cl. CPC B05C 11/1005; B05B 12/124

(57) ABSTRACT

The present invention relates to an apparatus (1) for coating a component, in particular a floor element (3), moved in a transport direction

with a coating device (5) for applying a coating medium to the floor element (3),

with at least one actuator (7) for adjusting a position of the coating device (5) relative to the floor element (3), and

with at least one detection device (9) for detecting the coating device (5) and/or the component, in particular the floor element (3).

### CLAIM OF BENEFIT OF FILING DATE

The present application is a 371 of International Application No. PCT/EP 2024/060737, filed Apr. 19, 2024, which claims the benefit of German Application No. 10 2023 110 073.4, filed on Apr. 20, 2023, the content of which is hereby expressly incorporated by reference in its entirety for all purposes.

### FIELD

The present invention relates to an apparatus and method for coating a component, in particular a floor element. Furthermore, the invention relates to an apparatus for manufacturing a component, in particular a floor element.

The invention can be used in the manufacture of at least partially coated components, such as floor elements, furniture elements, ceiling panels, or door elements.

### BACKGROUND

Flooring elements, in particular those with a tongue-and-groove or click connection, are usually manufactured using so-called double-end profilers. Double-end profilers are apparatuses that convey elongated substrates, in particular made of wood, along a transport direction, whereby a profile is milled into the substrate on both sides during conveyance. In addition to producing the profile, double-end profilers can also have one or more coating devices, which are used to coat one or more chamfers or even seal the entire profile. Coating devices can, for example, be designed in the form of a transfer wheel or as a vacuum coating device.

The fine adjustment of the position of such coating devices, in particular relative to the floor element, is of decisive importance for the coating result. If the fine adjustment is carried out when the double-end profiler is at a standstill, deviations from an optimum coating result may occur when it is put into operation and/or due to operational peculiarities. Consequently, fine adjustment is carried out in accordance with the state of the art while the double-end profiler is in operation. In this case, an operator enters or reaches into a safety area of the double-end profiler and observes the coating result manually, i.e., using a mirror. If necessary, the operator manually fine-tunes the position of the coating device using adjustment elements until the desired coating result is achieved. This procedure has the disadvantage that it requires entering a safety area, which is associated with an increased risk of accidents. Furthermore, the quality of the fine adjustment depends on the subjective perception and individual skills of the operator and can therefore vary from operator to operator. As a result, it can be difficult to reproduce an optimal coating result.

Against this background, the problem is to provide an optimized solution for fine-tuning the position of coating devices, which avoids or at least reduces the aforementioned disadvantages in the prior art, in particular the need to enter a safety zone and the associated risk of accidents.

To solve this problem, an apparatus for coating a component, in particular a floor element, moving in a transport direction is proposed,
with a coating device for applying a coating medium to the floor element,
with at least one actuator for adjusting a position of the coating device relative to the component, in particular the floor element, and
with at least one detection device for detecting, in particular optically, the coating device and/or the component, in particular the floor element.

### SUMMARY

According to the subject matter of the invention, the apparatus for coating a floor element moved in a transport direction has a coating device for applying a coating medium to the floor element. The coating device can be designed in particular as a transfer wheel or vacuum coating device. Furthermore, the device has an actuator for adjusting the position of the coating device relative to the floor element. The actuator can be designed in particular as a servo motor or stepper motor. In addition, the device has a detection device for, in particular optically, detecting the coating device and/or the floor element. The detection device can be used to, in particular, optically detect the coating device, its exact position or its distance from the floor element or from a chamfer of the floor element. This has the advantage that the operator of the device does not have to enter a safety area, but can obtain an accurate picture of the coated area of the floor element or of the coating result from a safe distance. In addition, the position of the coating device can be adjusted much more precisely using the actuator than manually by one or more users. In particular, the position can be reproduced much more precisely, as it is not set subjectively by a user, but can be repeated in a controlled manner by the actuator.

Furthermore, the invention facilitates the training of a first user by a second user of the device who is already familiar with it. This is because the detection device makes it possible for both users to remain outside the safety area and still obtain an accurate picture of the coated area of the component, in particular the floor element, or of the coating result.

The at least one actuator is preferably configured to adjust several positions of the coating device relative to the component. The apparatus preferably comprises several actuators for adjusting one or more positions of the coating device relative to the component. Preferably, several detection devices are provided for detecting the coating device and/or the component. Although the invention is described below with reference to a component designed as a floor element, the apparatus according to the invention can also be used to coat other components, for example to coat a furniture element, a ceiling panel or a door element, for example a door leaf or a door frame element.

Preferably, the detection device detects a coated area and/or an uncoated area of the component, in particular the floor element. The uncoated area can be detectable in the transport direction of the component, in particular the floor element, before the coating device or in the transport direction after the coating device. Particularly preferably, the detection device detects both at least part of the coating device and at least part of the component, in particular the floor element.

According to a preferred embodiment of the invention, the one or more detection devices are designed to detect a coating applied to the component, in particular the floor element, and/or defects in a coating applied to the component, in particular the floor element.

According to a preferred embodiment of the invention, the detection device is designed as a camera that captures a camera image, wherein the apparatus has a display device for displaying the camera image captured by the camera. The display device can be arranged at a sufficiently large distance from the coated area so that the user of the display device does not have to enter the safety area. The display device may comprise one or more screens. Multiple screens may be advantageously used, for example, to display coating results at different times or at different positions of the coating device on the screens, thereby enabling comparisons to be made.

According to a preferred embodiment of the invention, the detection device is designed as a laser scanner. The laser scanner can be used to measure the contour of the floor element, in particular a profile of the floor element. The laser scanner also enables depth information to be detected, so that a three-dimensional image of the floor element and its position in the room can be captured. Preferably, the apparatus comprises a display device for displaying measurement data determined by the laser scanner and/or for displaying a contour of the coating device determined by the laser scanner and/or for displaying a contour of the floor element determined by the laser scanner. The display device can be arranged at a sufficiently large distance from the coated area so that the user of the display device does not have to enter the safety area. The display device can have one or more screens. Multiple screens can be used advantageously, for example, to display coating results at different times or at different positions of the coating device on the screens, thereby enabling comparisons to be made.

According to a preferred embodiment of the invention, the detection device is designed as an acoustic sensor. The acoustic sensor can be an airborne sound sensor or a structure-borne sound sensor. Preferably, the acoustic sensor is designed to detect vibrations. The acoustic sensor enables the coating device and/or the floor element to be detected even under poor optical conditions, for example in low light. Preferably, the apparatus comprises a display device for displaying measurement data determined by means of the acoustic sensor and/or for displaying a contour of the coating device determined by means of the acoustic sensor and/or for displaying a contour of the floor element determined by means of the acoustic sensor. The display device may be arranged at a sufficiently distance from the coated area so that the user of the display device does not have to enter the safety area. The display device may have one or more screens. Multiple screens can be used advantageously, for example, to display coating results at different times or at different positions of the coating device on the screens, thereby enabling comparisons.

According to a preferred embodiment of the invention, the detection device is designed as a weight sensor. Preferably, the weight sensor is designed to detect the weight of the coating device. By detecting the weight of the coating device, contact with the coating device by the component can be detected.

According to a preferred embodiment of the invention, the detection device is designed as a force sensor. Preferably, the force sensor is designed to detect forces acting on the coating device. By detecting the forces acting on the coating device, contact between the component and the coating device can be detected.

According to a preferred embodiment of the invention, the detection device is designed as a distance measuring sensor. Preferably, the distance measuring sensor is designed to detect a distance between the coating device and the component. By detecting this distance, contact between the coating device and the component can be detected.

According to a preferred embodiment of the invention, the device comprises several detection devices for detecting the coating device and/or the component, in particular the floor element. The multiple detection devices may be of the same type, i.e., they may each be designed as a camera, or each as a laser scanner, or each as an acoustic sensor, or each as a weight sensor, or each as a force sensor, or each as a distance measuring sensor. It is particularly preferred that the plurality of detection devices are designed differently. For example, a first detection device may be designed as a camera and a second detection device may be designed as a laser scanner. Alternatively, a first detection device may be designed as a camera and a second detection device may be designed as an acoustic sensor. Alternatively, a first detection device may be designed as a camera and a second detection device may be designed as a laser scanner, and a third detection device may be designed as an acoustic sensor. Furthermore, a first detection device may be designed as a camera, a second detection device as a laser scanner, and a third detection device as an acoustic sensor. In addition, a weight sensor and/or a force sensor and/or a distance measuring sensor may be provided.

An advantageous embodiment of the invention provides a control device that is designed to control the actuator in response to a user input. If the device additionally comprises a display device, this can be designed as a common unit with the control device. However, the control device can also be designed separately, i.e., independently of the display device. The control device can, for example, comprise a control stick or joystick for actuating the actuator. A mechanical transmission between the joystick and the actuator may be provided for fine adjustment of the position of the coating device. In other words, movement of the joystick in a first direction by an amount x may result in movement of the coating device in the same direction by an amount, for example, 0.1x, caused by the actuator. Alternatively or additionally, the user's input can be made via levers or buttons or pushbuttons or switches. For example, the control device can have a selector switch for selecting a spatial direction and one or more pushbuttons for activating an adjustment process in a spatial direction selected by means of the selector switch by a predetermined increment. Preferably, the control device comprises a further selector switch for selecting a predetermined increment. It is also conceivable that the display device and the control device are designed as a single unit, so that, for example, the actuator and thus the position of the coating device can be controlled via a touch-sensitive display device (touchscreen).

According to an advantageous embodiment, the control device is arranged in the immediate vicinity of the coating device. Such a design is particularly advantageous if there is a further control device via which, in addition to the aforementioned coating device, other systems, for example further coating devices, can also be controlled. This further control device may be located at a position further away from the coating device, for example in a separate control room. In this case, the provision of the first-mentioned control device enables operation by a user in the immediate vicinity of the coating device.

It is advantageous if the device comprises an evaluation unit for evaluating measurement data detected by the detection device, which is designed to evaluate the coating result and generate at least one recommendation for achieving an improved coating result. Preferably, the evaluation unit is designed to generate several alternative recommendations so that an operator of the device can be presented with several alternatives, for example, for achieving several qualitatively different coating results. The recommendations may, for example, comprise one or more adjustable parameters of the actuator and/or the coating device. Evaluating the coating result may, for example, comprise determining defects in the coating and/or determining unintentionally coated areas of the floor element.

It is preferred that the apparatus includes a display device for displaying an evaluation of the coating result by the evaluation unit. The display device may, for example, be designed in the manner of a scale and/or in the manner of a color display. For example, the display device may display the evaluation in color-coded form, e.g., green for a good coating result, yellow for a satisfactory coating result, and red for a poor coating result.

If a control device is provided, it may comprise an operating element for activating automatic cleaning of a scraper. The scraper may be configured in an operating position for scraping excess coating medium from the floor element. By actuating the aforementioned operating element, the scraper can be moved from the operating position to a cleaning position. Contamination on the scraper can be removed automatically when it is moved into the cleaning position or manually or mechanically in the cleaning position. Appropriate stops may be provided to define the operating position and the cleaning position; these are optionally adjustable.

According to an advantageous embodiment of the invention, a controller is provided which is designed to control the actuator depending on output data from the detection device, for example the camera image. The controller can generate an instruction for the actuator depending on the output data from the detection device. The controller can have a database in which a large number of camera images are stored, with each camera image being assigned an instruction that corresponds to a position of the coating device. The database can be created and expanded using artificial intelligence in the course of a training procedure. The controller can also have image analysis software that can analyze a current camera image and compare it with camera images stored in the database in order to find the most suitable instruction for the actuator. Alternatively or additionally, a deterministic algorithm may be implemented in the controller, as hardware and/or as software, which analyzes the data determined by the detection device and generates an instruction for the actuator depending on this data.

It is preferred that the actuator has two sub-actuators for adjusting the position of the coating device relative to the floor element in two spatial directions arranged at an angle to each other, in particular perpendicular to each other. Depending on the profile or geometry of the coated or to-be-coated area of the floor element, movements of the coating device in different spatial directions may be necessary. Furthermore, the exact design of the coating device determines the spatial directions in which the corresponding coating device is to be moved. The two spatial directions in which the position of the coating device can be adjusted are preferably arranged parallel and perpendicular to a surface of the component, in particular the floor element, to be coated. If the coating device is designed as a transfer wheel, it is preferably movable by means of the actuator perpendicular and parallel to a chamfer of the floor element. If the coating device is designed as a vacuum coating device, it is preferably movable in two spatial directions perpendicular to the transport direction. A partial actuator may be provided for each spatial direction. Three or more partial actuators are also conceivable.

It is preferred that the at least one actuator is designed to change the position of the coating device relative to the component, in particular the floor element, in a direction parallel to a chamfer of the component to be coated.

According to a preferred embodiment of the invention, the actuator is designed to move the coating device in steps of 0.1 mm, preferably 0.01 mm. For precise reproducibility of the position of the coating device, the entire movement range of the coating device, i.e., each movement increment of the actuator, can be divided into discrete intervals of equal size for each spatial direction. Using the control device, the user of the apparatus can incrementally initiate a desired movement of the coating device.

A preferred embodiment of the invention provides that the detection device is arranged downstream of the coating device with respect to the transport direction of the device. The detection device can be directed against the transport direction onto the coated or to-be-coated area of the floor element. Preferably, the device has several detection devices, which are preferably all arranged downstream of the coating device. Using detection devices formed by several cameras, for example, several camera images can be generated simultaneously, which can be displayed on one or more display devices.

According to a preferred embodiment of the invention, the detection device is mechanically connected to the coating device. Attaching the detection device to the coating device has the advantage that the detection device can be aligned more precisely with the area to be optically detected, i.e., the area of the floor element to be coated. This facilitates assembly, as instead of two devices, only one unit consisting of the detection device and the coating device needs to be mounted on the double-end profiler. In addition, time can be saved during assembly, as there is no need to adjust the alignment of the detection device during assembly.

Alternatively, it may be provided that the detection device and the coating device are mechanically decoupled and/or arranged separately from each other. In this way, for example, undesirable stress on the coating device due to the weight of the detection device or due to forces acting on the detection device can be reduced or avoided.

According to a preferred embodiment of the invention, the detection device can be selectively moved relative to the coating device from a rest position, in particular a protected rest position, to a detection position in which the coating device and/or the component can be detected. To move the detection device from the rest position to the detection position, and in particular vice versa, the device may comprise a detection device actuator. In the rest position, the detection device may be arranged in such a way that contamination by the coating device is not to be feared.

An advantageous embodiment of the invention provides-when using a detection device for optically detecting the coating device and/or the floor element-a mirror arranged in a beam path between the coating device and the detection device. The mirror may in particular be designed as a one-way mirror, i.e., it is possible to see through one side of the mirror, while the rear side of the mirror can largely reflect light. As a result of the mirror being arranged in a beam path between the coating device and the detection device, light beams can be advantageously deflected and directed to the detection device, so that optical detection of the coated area is possible, as it were, around the corner.

According to a further advantageous embodiment of the invention, the mirror is arranged in such a way that the area of the floor element coated by the coating device can be detected directly by the detection device and the coating device can be detected indirectly by the camera via the mirror, or vice versa. In this respect, the mirror can cover part of the detection area of the detection device, e.g., half of it.

A transparent protective element is preferably provided to protect the detection device from contamination. The protective element is preferably designed to be replaceable or removable. Furthermore, the protective element is preferably made of glass or Plexiglas and can thus provide transparency for good optical detection by the detection device and easy cleaning.

According to a further advantageous embodiment of the invention, the protective element is designed as a removable protective film. Preferably, the protective film can be removed in the event of contamination, in particular at the request of a user or automatically, for example depending on data detected by the detection device. Alternatively, a removable protective film may be provided on the protective element. If the device comprises a mirror, a removable protective film may also be provided on the mirror.

Another object of the invention is an apparatus for manufacturing a component, in particular a floor element,
with a first conveyor device for conveying the component, in particular, the floor element, in a first transport direction,
with a first processing device for processing a section of the component, in particular the floor element, in particular during transport in the first transport direction, and
with a first apparatus for coating according to one of the preceding embodiments, in particular during transport in the first transport direction. The apparatus for manufacturing a floor element has the same advantages and technical effects as those already explained in the description of the apparatus for coating a floor element. The conveyor device may in particular comprise one or more conveyor belts and one or more chains. The processing device may also comprise one or more milling cutters for producing a profile, in particular chamfers, in the floor element which is or are arranged on one or both sides of the substrate or floor element.
Even though the invention is described below with reference to a component designed as a floor element, the device according to the invention can also be used to coat other components, for example to coat a furniture element, a ceiling panel or a door element, for example a door leaf or a door frame element.

According to a preferred embodiment of the invention, several first apparatuses for coating are provided according to one of the preceding embodiments, wherein the apparatuses for coating are arranged in such a way that a coating medium can be applied to opposite edges of the moving component, in particular the floor element, in particular during transport in the first transport direction.

According to an advantageous embodiment, the device comprises several first processing devices for processing a section of the component, in particular the floor element, in particular during transport in the first transport direction, wherein the processing devices are arranged such that opposite edges of the moving component, in particular the floor element, can be processed.

According to an advantageous embodiment, the device comprises a second conveyor device for conveying the component, in particular the floor element, in a second transport direction arranged perpendicular to the first transport direction, a plurality of second processing devices for processing a section of the component, in particular the floor element, in particular during transport in the second transport direction, wherein the processing devices are arranged such that that opposite edges of the moving component, in particular floor element, can be processed, and a plurality of second apparatuses for coating according to one of the embodiments described above, wherein the apparatuses are arranged such that a coating medium can be applied to opposite edges of the moved component, in particular floor element, in particular during transport in the second transport direction.

An advantageous design provides for a common monitoring unit, which comprises one or more control devices for controlling the actuators of the plurality of first and, if applicable, second apparatuses for coating a component, in particular a floor element, moved in a transport direction, depending on a user input. The common monitoring unit preferably also comprises one or more display devices for displaying the data detected by the detection devices of the plurality of apparatuses for coating a component, in particular a floor element, moving in a transport direction, in particular camera images and/or information derived therefrom. It is therefore not necessary for the user to move to different positions along the apparatus in order to monitor and adjust multiple devices. Instead, monitoring and operation can be carried out from a central location.

Another subject of the invention is a method for coating a component moved in a transport direction, in particular a floor element,
wherein a coating medium is applied to the component, in particular the floor element, by means of a coating device,
wherein the coating device and/or the component, in particular the floor element, is detected, in particular optically, by means of at least one detection device, and
wherein a position of the coating device relative to the component, in particular the floor element, is adjusted by means of at least one actuator. The same advantages and technical effects already explained in the description of the apparatus for coating a floor element also apply to the method according to the invention.

Even though the invention is described below with reference to a component designed as a floor element, the method according to the invention can also be used to coat other components, for example to coat a furniture element, a ceiling panel or a door element, for example a door leaf or a door frame element.

According to an advantageous embodiment of the invention, it is provided that the at least one actuator is controlled, in particular automatically, by means of a controller, depending on output data from the at least one detection device.

According to a further embodiment of the invention, the controller is designed as a self-learning artificial intelligence system that is trained in a training procedure.

According to an alternative advantageous embodiment, it is provided that the actuator is controlled depending on a user input.

In this context, an advantageous embodiment is one in which an evaluation unit evaluates the measurement data recorded by the detection device in order to assess the coating result and generates at least one recommendation for achieving an improved coating result, which is displayed to the user.

In the apparatus according to the invention for manufacturing a floor element and in the method according to the invention for coating a floor element moved in a transport direction, the advantageous embodiments and features described in connection with the apparatus for coating a floor element moved in a transport direction can also be applied alternatively or additionally, either alone or in combination with one another.

### BRIEF DESCRIPTION OF DRAWINGS

Further details and advantages of the invention will be explained below with reference to the embodiments shown in the figures. Herein,

FIG. 1 shows schematically a first embodiment of the apparatus according to the invention for coating a floor element in a side view;

FIG. 2 schematically shows a second embodiment of the apparatus according to the invention for coating a floor element in a side view;

FIG. 3 schematically shows a first embodiment of the apparatus according to the invention for manufacturing a floor element in a top view;

FIG. 4 schematically shows a sectional view A-A of a partial area of the apparatus from FIG. 3; and

FIG. 5 schematically shows a second embodiment of the apparatus according to the invention for manufacturing a floor element in a top view.

### DETAILED DESCRIPTION

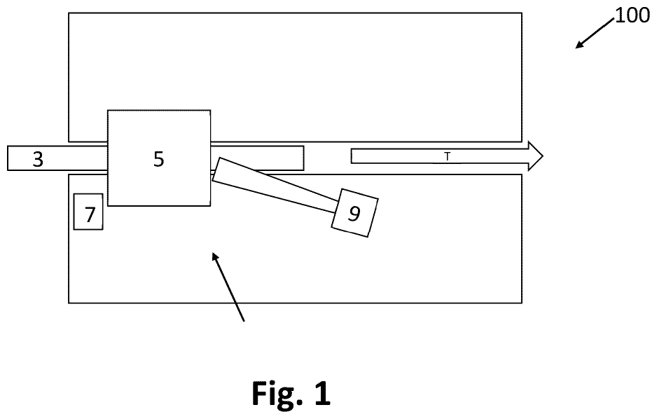

The representation in FIG. 1 schematically shows a first embodiment of the apparatus 1 according to the invention for coating a floor element 3 in a side view. The floor element 3 is moved in a transport direction T for coating. The apparatus 1 has a coating device 5 for applying a coating medium to the floor element 3. Furthermore, the apparatus 1 comprises an actuator 7 for adjusting a position of the coating device 5 relative to the floor element 3. In addition, the apparatus 1 has a detection device 9 designed as a camera, via which the coating device 5 and the floor element 3 are optically detected. For example, a camera image of an area of the floor element 3 that has been coated by the coating device 5 or that has not been coated and is not visible in FIG. 1 can be captured as a camera image.

The creation of the camera image allows a user of the apparatus 1 to optically detect the coated area of the floor element 3 while maintaining a safe distance. In addition, the position of the coating device 5 can be adjusted precisely, objectively, and reproducibly by means of the actuator 7.

The floor element 3 is preferably conveyed in the transport direction T by a conveyor device, for example a conveyor device comprising one or more conveyor belts and/or one or more chains.

According to a modification of the embodiment shown in FIG. 1, the detection device 9 can be designed as a laser scanner or as an acoustic detection device. As a further alternative, it is possible for there to be several detection devices 9, for example a first detection device 9 designed as a camera and a second detection device designed as a laser scanner and/or a third detection device designed as an acoustic detection device.

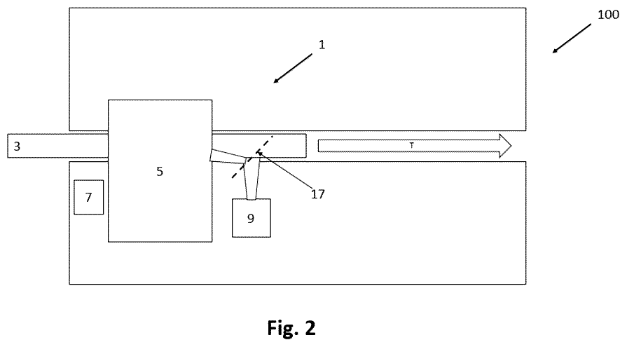

FIG. 2 schematically shows a second embodiment of the apparatus 1 according to the invention for coating the floor element 3 in a side view. The second embodiment according to FIG. 2 differs from the first embodiment according to FIG. 1 essentially in a mirror 17 and a modified arrangement of the camera 9. Due to its orientation, the mirror 17 enables optical detection, as it were, around the corner. This allows the camera 9 to take camera images with a lower risk of contamination. The mirror 17 indicated by a dashed line and its exact orientation are to be understood schematically.

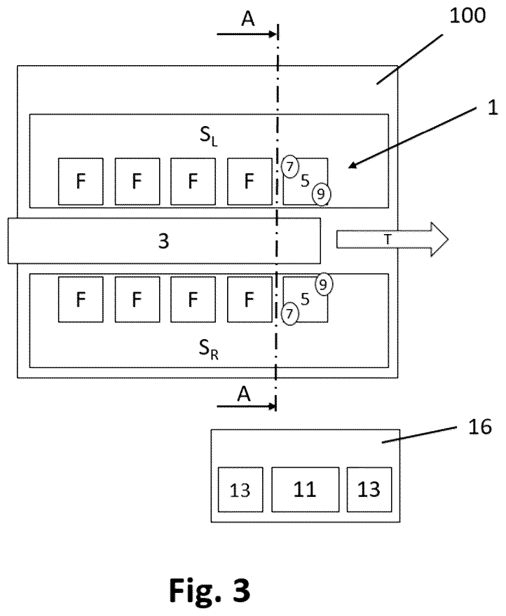

FIG. 3 schematically shows a first embodiment of the apparatus 100 according to the invention for manufacturing a floor element 3 in a top view. The apparatus 100 is designed as a double-end profiler and comprises an apparatus 1 for coating floor elements 3. Furthermore, the apparatus 100 has a left safety area S_{L} and a right safety area S_{R}. A floor element 3 can be conveyed between the safety areas S_{R} and S_{L} along the transport direction T. During conveyance the floor element 3 can be mechanically processed on both sides by means of several milling cutters F. The milling cutters F can be arranged differently in order to incorporate chamfers, grooves, tongues or the like into the floor element 3.

Following the mechanical processing, the substrate or floor element 3 can be painted or coated on both sides by means of two coating devices 5. It is also conceivable that the floor element 3 could be sealed, i.e., completely coated with regard to its surface. The cameras 9 can be used to determine the respective position of the coating devices 5. If necessary, a user can change the position of the coating devices 5 using the actuators 7 in order to optimize the coating result.

The apparatus 1 for manufacturing a floor element 3 has an observation unit 16 which is arranged at a sufficient distance from the safety areas S_{R} and S_{L}. The monitoring unit 16 comprises a display device 11 and two control devices 13, each for the visual detection and control of the actuators 7 and thus of the coating devices 5. A user of the apparatus 1 can control the actuators 7 of both coating devices 5 from the monitoring unit 16.

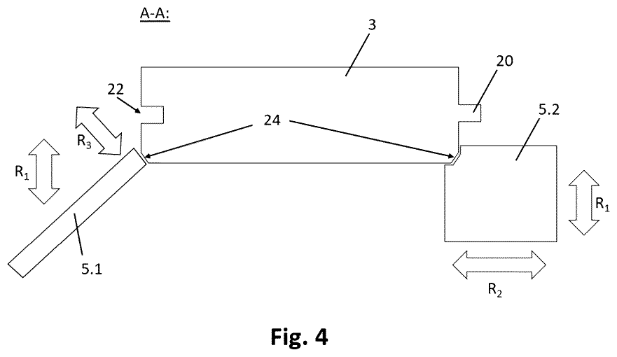

FIG. 4 shows a schematic cross-sectional view A-A of a section of the apparatus 100 from FIG. 3. After mechanical processing by means of the milling machines F, the floor element 3 has two chamfers 24 on opposite sides of the floor element 3. Furthermore, the floor element 3 has a tongue 20 and a chamfer 24. The two chamfers 24 are each coated with a coating device 5, namely by means of a transfer wheel 5.1 and a vacuum coating system 5.2. The vacuum coating system 5.2 can be moved along a first spatial direction R₁ and along a second spatial direction R₂ by means of two partial actuators of an actuator 7 in order to control the relative distance between the floor element 3 and the vacuum coating system 5.2 and, as a result, the coating result. Similarly, the transfer wheel 5.1 can be moved by means of two further partial actuators of a further actuator 7 along the first spatial direction R₁ and along a third spatial direction R₃, wherein the third spatial direction R₃ runs parallel to the chamfer 24 formed on the left in FIG. 4.

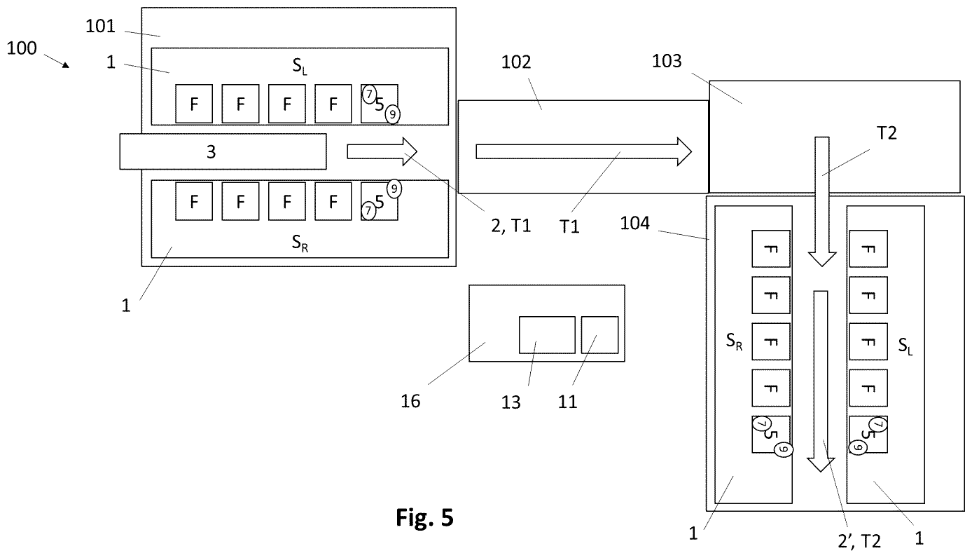

FIG. 5 schematically shows a second embodiment of the apparatus 100 according to the invention for manufacturing a floor element 3 in a top view. The apparatus 100 comprises a first double-end profiler 101 and a second double-end profiler 104, between which a device for changing the transport direction 103 is arranged, so that the first double-end profiler 101 can process and coat two sides of the floor element 3 during transport in a first transport direction T1, here the longitudinal direction, while the second double-end profiler 104 can process and coat the floor element 3 during transport in a second transport direction T2, here the transverse direction. For drying, a drying device 102 is additionally arranged between the first and second double-end profilers 101, 104, which dries the floor element 3 during transport in the first transport direction T1, here the longitudinal direction.

The first and second double-end profilers 101, 104 each have a left safety area S_{L} and a right safety area S_{R}. The floor element 3 is conveyed between the safety areas S_{R} and S_{L}, along the respective first and second transport directions T1, T2, by a first and second conveyor device 2, 2′. During transport, the floor element 3 can be mechanically processed on both sides by means of several milling cutters F. The milling cutters F can be arranged in different ways in order to cut chamfers, grooves, tongues or the like into the floor element 3.

Following the mechanical processing, the substrate or floor element 3 is painted or coated on both sides by means of two coating devices 5 of the respective double-end profiler 101, 104. It is also conceivable that the floor element 3 is sealed, i.e., completely coated with regard to its surface. The respective position of the coating devices 5 can be determined by means of the detection devices, for example cameras, 9. Alternatively, the detection device 9 can be designed as a laser scanner or as an acoustic detection device. As a further alternative, it is possible to have several detection devices 9, for example a first detection device 9 designed as a camera and a second detection device designed as a laser scanner and/or a third detection device designed as an acoustic detection device.

The apparatus 1 for manufacturing a floor element 3 has a common observation unit 16 which is arranged at a sufficient distance from the safety areas S_{R} and S_{L}. The observation unit 16 comprises a display device 11 and two control devices 13, each for the optical detection and control of the actuators 7 and thus of the coating devices 5. The display device 11 allows an operator to view the data recorded by the detection devices 9, for example camera images. The display device can also show parameters of the apparatus 1 for manufacturing a floor element. In addition, it is possible for an evaluation unit to evaluate the coating result detected by the detection devices 9 and generate at least one recommendation for achieving an improved coating result. Preferably, the evaluation unit is designed to generate several alternative recommendations so that an operator of the device can be presented with several alternatives. For example, defects in coating with a specific coating device 5 can be detected and a recommendation can be issued on how to position the coating device relative to the floor element 3 in order to avoid the defects. For this purpose, a color of the paint and its position within the captured camera image can be determined in the captured camera image by a detection device designed as a camera. With a detection device designed as a laser scanner or acoustic detection device, unevenness in a surface contour of the floor element can be determined.

An operator of the apparatus 1 can control the actuators 7 of both double-end profilers 101, 101 from the observation unit 16. In particular, the operator can change the position of the coating devices 5 by means of the actuators 7 in order to optimize a coating result.

### REFERENCE SYMBOLS

1 apparatus for coating
2 conveyor device
2′ conveyor device
3 floor element
5 coating device
5.1 transfer wheel
5.2 vacuum coating system
7 actuator
9 detection device
11 display device
13 control device
16 observation unit
17 mirror
20 tongue
22 groove
24 chamfer
100 apparatus for manufacturing a floor element, double-end profiler
101 double end profiler
102 drying device
103 device for changing the transport direction
104 double-end profiler
F milling machine
R₁ First spatial direction
R₂ second spatial direction
R₃ third spatial direction
S_{R} right safety area
S_{L} left safety area
T transport direction
T1 transport direction
T2 transport direction

1. An apparatus for coating a component, in moved in a transport direction, comprising:
a coating device for applying a coating medium to the floor element;
at least one actuator for adjusting a position of the coating device relative to the component, and
at least one detection device for detecting the coating device;
wherein the at least one detection device is designed to detect a position of the coating device.

2. (canceled)

3. The apparatus according to claim 1, wherein the at least one detection device is designed to detect a coating applied to the component and/or defects in a coating applied to the component.

4. The apparatus according to claim 1, wherein the at least one detection device is designed as a camera which captures a camera image.

5. (canceled)

6. (canceled)

7. (canceled)

8. (canceled)

9. (canceled)

10. (canceled)

11. The apparatus according to claim 1, wherein the apparatus comprises several detection devices for detecting the coating device and/or the component.

12. The apparatus according to claim 1, wherein the apparatus comprises a control device which is designed to control the at least one actuator depending on a user input, and wherein the control device is arranged in an immediate vicinity of the coating device.

13. (canceled)

14. The apparatus according to claim 1, wherein the device apparatus comprises an evaluation unit for evaluating measurement data detected by the at least one detection device, which is designed to evaluate a coating result and generate at least one recommendation for achieving an improved coating result.

15. The apparatus according to claim 1, wherein the apparatus comprises a controller which is designed to control the at least one actuator depending on output data from the at least one detection device.

16. The apparatus according to claim 1, wherein the at least one actuator has two sub-actuators for adjusting the position of the coating device relative to the component in two spatial directions arranged at an angle to each other.

17. The apparatus according to claim 1, wherein the at least one actuator is designed to change the position of the coating device relative to the component in a direction parallel to a chamfer of the component to be coated.

18. The apparatus according to claim 1, wherein the at least one actuator is designed to move the coating device in steps of 0.1 mm, or less.

19. The apparatus according to claim 1, wherein the at least one detection device is arranged downstream of the coating device with respect to the transport direction of apparatus.

20. The apparatus according to claim 1, wherein the at least one detection device is mechanically connected to the coating device.

21. The apparatus according to claim 1, wherein the at least one detection device and the coating device are mechanically decoupled and/or arranged separately from each other.

22. The apparatus according to claim 1, wherein the at least one detection device can be selectively moved relative to the coating device from a rest position into a detection position in which the coating device and/or the component can be detected.

23. The apparatus according to claim 1, wherein the apparatus comprises a mirror arranged in a beam path between the coating device and the at least one detection device and wherein the mirror is arranged in such a way that an area of the component coated by the coating device can be detected directly by the at least one detection device and the coating device can be detected indirectly by the at least one detection device via the mirror. or vice versa.

24. (canceled)

25. (canceled)

26. (canceled)

27. (canceled)

28. (canceled)

29. An apparatus for manufacturing a component, comprising:
a first conveyor device for conveying the component in a first transport direction,,
a first processing device for processing a section of the component during transport in the first transport direction; and
a first apparatus for coating according to claim 1 during transport in the first transport direction.

30. The apparatus according to claim 29, wherein:
the apparatus comprises a plurality of first apparatuses for coating wherein each of the first apparatuses comprises:
a coating device for applying a coating medium to the floor element:
at least one actuator for adjusting a position of the coating device relative to the component; and
at least one detection device for detecting the coating device.
wherein the at least one detection device is designed to detect a position of the coating device;
wherein the first apparatuses are arranged such that a coating medium can be applied to opposite edges of the moving component during transport in the first transport direction; and/or
the apparatus comprises a plurality of first processing devices for processing a section of the component when conveying in the first transport direction, wherein the first processing devices are arranged in such a way that opposite edges of the moving component can be processed.

31. (canceled)

32. The apparatus according to claim 29 comprising:
a second conveyor device for conveying the component in a second transport direction arranged perpendicular to the first transport direction;
a plurality of second processing devices for processing a section of the component during transport in the second transport direction, wherein the plurality of second processing devices are arranged in such a way that opposite edges of the component can be processed; and
a plurality of second apparatuses for coating, wherein each of the second apparatuses comprises:
a coating device for applying a coating medium to the floor element:
at least one actuator for adjusting a position of the coating device relative to the component and
at least one detection device for detecting the coating device:
wherein the at least one detection device is designed to detect a position of the coating device:
wherein the plurality of second apparatuses are arranged such that a coating medium can be applied to opposite edges of the component during conveyance in the second transport direction.

33. The apparatus according to claim 29, wherein the apparatus comprises a common monitoring unit comprising one or more control devices for controlling the at least one actuator of the first apparatus and/or one or more second apparatuses in response to a user input.

34. (canceled)

35. A method for coating a component moved in a transport direction comprising:
applying a coating medium is applied to the component, by means of a coating device;
detecting a position of the coating device and/or the component by means of at least one detection devices; and
adjusting the position of the coating device relative to the component, by means of at least one actuator

36. (canceled)

37. (canceled)

38. (canceled)

39. (canceled)
